(19) United States
(12) Patent Application Publication
(10) Pub. No.: US 2020/0321757 A1
(43) Pub. Date: Oct. 8, 2020

(54) WIRE HARNESS AND METHOD FOR MANUFACTURING THE SAME

(71) Applicant: YAZAKI CORPORATION, Tokyo (JP)

(72) Inventor: Yukihiro Kawamura, Makinohara-shi (JP)

(21) Appl. No.: 16/840,301

(22) Filed: Apr. 3, 2020

(30) Foreign Application Priority Data
Apr. 5, 2019 (JP) 2019-072371

(51) Int. Cl. H02G 3/04; H01B 7/00; H01B 13/012

(52) U.S. Cl. CPC H02G 3/0468; B60R 16/0215; H01B 13/01209; H01B 7/0045

(57) ABSTRACT

A wire harness includes an electric wire having flexibility, and a flexible tubular body that has no slit on an entire region from one end to the other end of the tubular body and accommodates the electric wire. A route regulation portion for restricting the tubular body to a desired route shape is provided in a predetermined range of the tubular body in a tube axis direction of the tubular body in a state where the electric wire is accommodated in the tubular body. The route regulation portion has an injection hole that is provided in a peripheral wall of the tubular body so as to pass through the peripheral wall, and a cured portion that is injected through the injection hole and is cured in the tubular body.

### CROSS REFERENCE TO RELATED APPLICATIONS

This application is based on Japanese Patent Application (No. 2019-072371) filed on Apr. 5, 2019, the contents of which are incorporated herein by reference.

### BACKGROUND OF THE INVENTION

### 1. Field of the Invention

The present invention relates to a wire harness in which a route regulation is necessary. Further, the present invention relates to a method for manufacturing the wire harness.

### 2. Description of the Related Art

A wire harness in the related art that is routed in an automobile includes one or a plurality of electric wires, a tubular corrugated tube through which the electric wire is inserted, and a connector provided at an end portion of the electric wire. In a wire harness disclosed in JP-A-2012-90503, a protector is attached to a corrugated tube, into which an electric wire is inserted, to regulate a route of the corrugated tube. Further, in a wire harness disclosed in JP-A-2013-5605, a route maintaining member is assembled to a slit of a corrugated tube in order to regulate a route of the corrugated tube. The route maintaining member includes an elastic mounting portion. The elastic mounting portion is a molded product made of an elastomer such as rubber.

In the related art described above, since the molded product is molded using a mold for the route regulation, it is necessary to provide a new mold each time if the route regulation range and shape are changed. That is, in the configuration and shape in the related art, the degree of freedom regarding the route regulation is low due to use of the mold. Further, in the related art described above, since the route-regulated portion is thickened due to the protector or the route maintaining member, it is necessary to secure a space for routing.

### SUMMARY OF THE INVENTION

The present invention has been made in view of the above circumstances, and an object of the present invention is to provide a wire harness and a method for manufacturing the wire harness in which the route-regulated portion can be prevented from being enlarged in size while increasing the degree of freedom regarding the route regulation.

The above-described object of the present disclosure is achieved by below-described structures and methods.

There is provided a wire harness, including:

an electric wire having flexibility; and

a flexible tubular body that has no slit on an entire region from one end to the other end of the tubular body and accommodates the electric wire, wherein

a route regulation portion for restricting the tubular body to a desired route shape is provided in a predetermined range of the tubular body in a tube axis direction of the tubular body in a state where the electric wire is accommodated in the tubular body; and

the route regulation portion has an injection hole that is provided in a peripheral wall of the tubular body so as to pass through the peripheral wall, and a cured portion that is injected through the injection hole and is cured in the tubular body.

According to the present invention having the above feature, since the wire harness includes the route regulation portion, the predetermined range can be formed into a desired route shape by the route regulation portion. The route regulation portion includes the injection hole and the cured portion, and the cured portion injected through the injection hole and cured in the tubular body contributes to the forming of the desired route shape. Since the cured portion is formed in the tubular body as described above, the route-regulated portion is not thickened. Further, since the route regulation portion is not a product molded by a mold, it can be relatively easy to handle the case in which the route regulation range and shape are diversified. The injection hole for forming the route regulation portion is a hole penetrating the peripheral wall of the tubular body, which does not lead to an increase in the number of components that complicates the management. Further, since the cured portion for forming the route regulation portion is also a portion that is injected through the injection holes and cured in the tubular body, similarly, which does not lead to an increase in the number of components that complicates the management. In the route regulation portion, if the cured portion is formed such that the electric wire is buried, for example, vibration of the electric wires can be prevented. In other words, flapping of the electric wire in the tubular body can be eliminated, and damage to the electric wire can be prevented (further, damage of a braid described later can be prevented), thus contributing to function maintaining. In addition, the tubular body is formed in a shape having no slit from one end to the other end, which can contribute to prevention of intrusion of dust or moisture. If it is necessary to prevent intrusion of dust or moisture from the injection hole, features of the prevent invention described above are effective.

For example, the cured portion has a hole blocking portion that blocks the injection hole.

According to the present invention having the above feature, the intrusion of dust or moisture from the injection hole can be prevented without increasing the number of components.

For example, the route regulation portion further has a plug member or a tape winding portion that blocks the injection hole.

According to the present invention having the above feature, the intrusion of dust or moisture from the injection hole can be prevented. Although the number of components is increased due to that the plug member is provided, the plug member is a member that only blocks the injection hole, there is no need to provide a new mold for the plug member each time even if the route regulation range and the shape are diversified. Further, the component is small and do not complicate the management. The injection holes can be commonly used even if there are a plurality of injection holes, so that the variation of the plug member is not increased.

For example, the tubular body is formed in a bellows shape in which bellows projection portions and bellows recess portions extending in a circumferential direction of the tubular body are alternately and continuously arranged in the tube axis direction.

According to the present invention having the above feature, due to the bellows shape that can increase a contact area of the cured portion in the tubular body, when the desired route shape is particularly straight, displacement of the cured portion can be reliably eliminated, and as a result, the function as the route regulation portion can be maintained. The displacement of the cured portion can be prevented by the feature of the relation between the cured portion and the hole blocking portion as described above.

For example, the wire harness further includes a braid that covers the electric wire and is accommodated in the tubular body together with the electric wire.

According to the present invention having the above feature, a wire harness having a shielding function can be provided. In the route regulation portion, if the cured portion is formed such that the electric wire is buried, for example, the vibration of the electric wire covered by the braid can be prevented by the cured portion, thereby preventing damage to the braid and contributing to the function maintaining.

There is also provided a method for manufacturing a wire harness, including:

accommodating an electric wire having flexibility in a flexible tubular body having no slit on an entire region from one end to the other end of the tubular body; and

forming a cured portion in a predetermined range of the tubular body in a tube axis direction of the tubular body after an accommodating process of the electric wire to form a route regulation portion which restricts the tubular body to a desired route shape, in which

a forming process of the cured portion includes:
holding the predetermined range of the tubular body in the desired route shape while a flexible state of the tubular body is maintained,
injecting a fluid to be the cured portion through an injection hole provided in a peripheral wall of the tubular body into inside the tubular body; and
curing the fluid to form the cured portion in the tubular body.

According to the present invention having the above feature, a wire harness including a route regulation portion can be manufactured. That is, the wire harness including the above structures can be manufactured.

For example, a jig used in the forming process of the cured portion has a holding portion that holds the predetermined range of the tubular body in a lower position lower than a part of the tubular body other than the predetermined range of the tubular body.

According to the present invention having the above feature, the fluid serving as the source of the cured portion can be kept within a predetermined range, for example, even without using a special device such as a suction device.

For example, the forming process of the cured portion is performed in a vicinity of a place where a wire harness routing of the wire harness is performed.

According to the present invention having the above feature, since the flexible electric wire and tubular body are provided, the wire harness can be easily stored until just before the routing of the wire harness. Further, when it is necessary to transport the wire harness to the routing site after the first step is performed, for example, the wire harness can be rolled into a compacted transport state.

According to the wire harness of the present invention, the degree of freedom regarding the route regulation can be increased, and the route-regulated portion can be prevented from being enlarged in size as compared with an example in the related art. Further, according to the method for manufacturing a wire harness of the present invention, the wire harness described above can be manufactured.

### BRIEF DESCRIPTION OF DRAWINGS

FIGS. 1A and 1B show a wire harness according to an embodiment of the present invention. FIG. 1A is a perspective view of the wire harness, and FIG. 1B is a perspective view of the wire harness in which a tubular body is shown by a two-dot chain line.

FIG. 2 is an enlarged perspective view of a route regulation portion of the wire harness shown in FIGS. 1A and 1B.

FIG. 3 is a perspective view of electric wires and a cured portion of the wire harness shown in FIGS. 1A and 1B (the tubular body is omitted, and the cured portion is schematically shown).

FIGS. 4A and 4B show a method for manufacturing a wire harness according to an embodiment of the present invention, and FIGS. 4A and 4B illustrate a first step of the method for manufacturing the wire harness.

FIGS. 5A, 5B and 5C show a second step of the method for manufacturing the wire harness. FIG. 5A illustrates a holding step in the second step, FIG. 5B illustrates an injection step, and FIG. 5C illustrates a curing step.

FIGS. 6A and 6B are cross-sectional views showing a state of the cured portion. FIG. 6A shows that a hole blocking portion is formed, and FIG. 6B shows that a plug member is attached.

FIG. 7 illustrates a jig used in the method for manufacturing the wire harness.

FIG. 8A shows that a route-regulated portion is not enlarged in size as compared with that shown in FIG. 8B. FIG. 8A is a perspective view showing the wire harness of FIGS. 1A and 1B, and FIG. 8B is a perspective view showing a wire harness as a comparative example.

### DETAILED DESCRIPTION OF THE EXEMPLARY EMBODIMENTS

A wire harness includes one or a plurality of flexible electric wires, and a flexible tubular body that is formed in a shape having no slit at an entire region from one end to the other end of the flexible tubular body and accommodates the electric wires. In a predetermined range in a tube axis direction of the flexible tubular body in a state where the electric wires are accommodated in the tubular body, a route regulation portion for restricting the tubular body to a desired route shape is formed. The route regulation portion includes one or a plurality of injection holes penetrating a peripheral wall of the tubular body, and a cured portion that is injected through the injection holes and is cured in the tubular body. In a step for forming the route regulation portion, a holding step of holding the predetermined range in the desired route shape while a flexible state of the flexible tubular body is maintained, an injection step of injecting a fluid serving as a source of the cured portion, and a curing step of forming the cured portion in the tubular body are performed.

### Embodiment 1

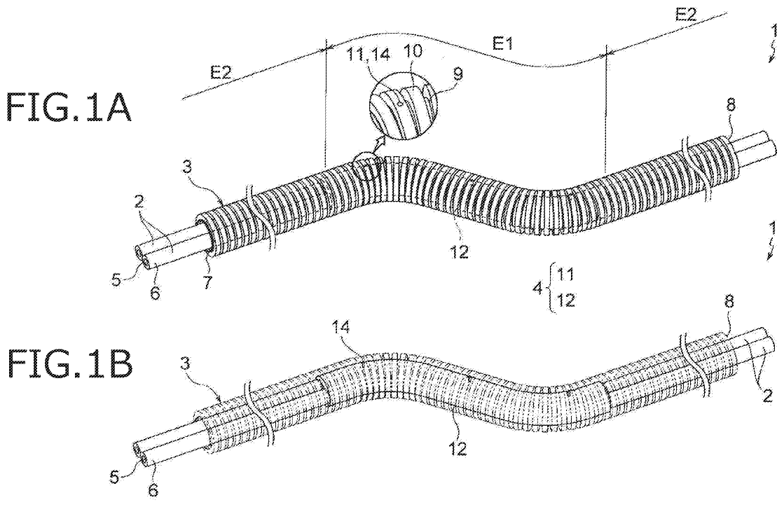

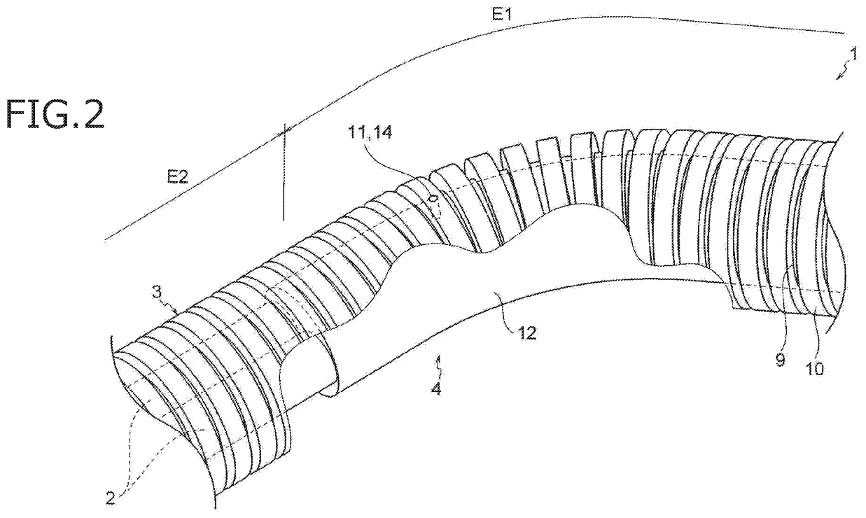

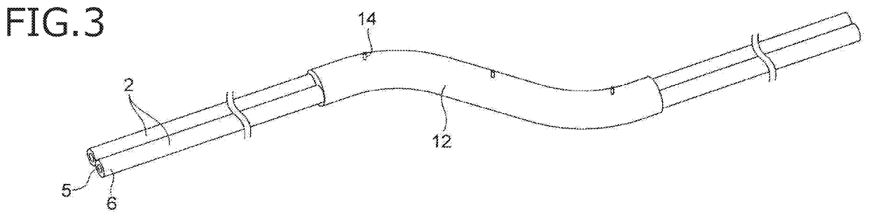

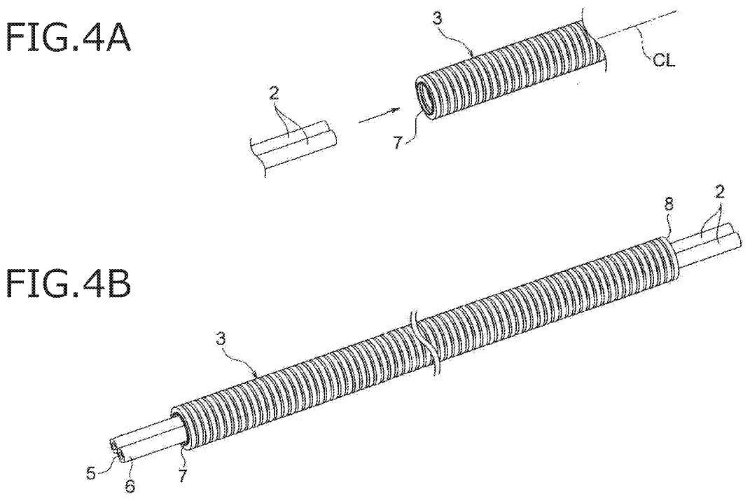

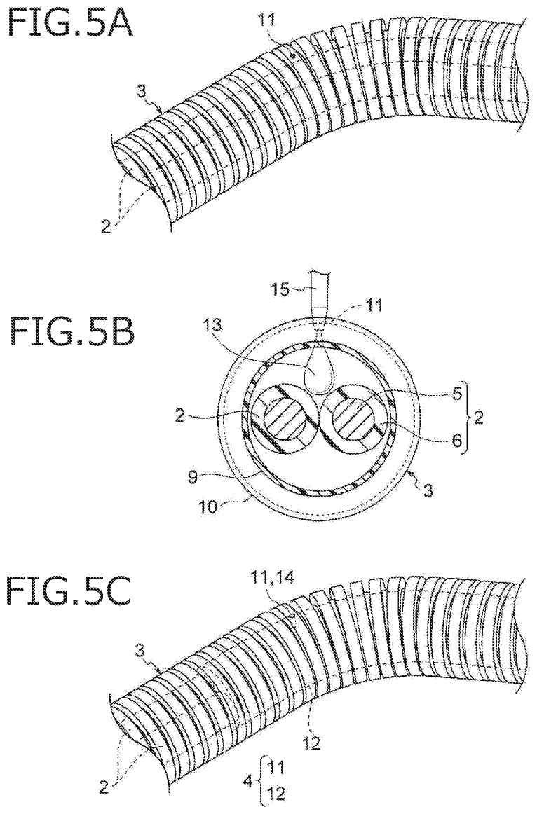

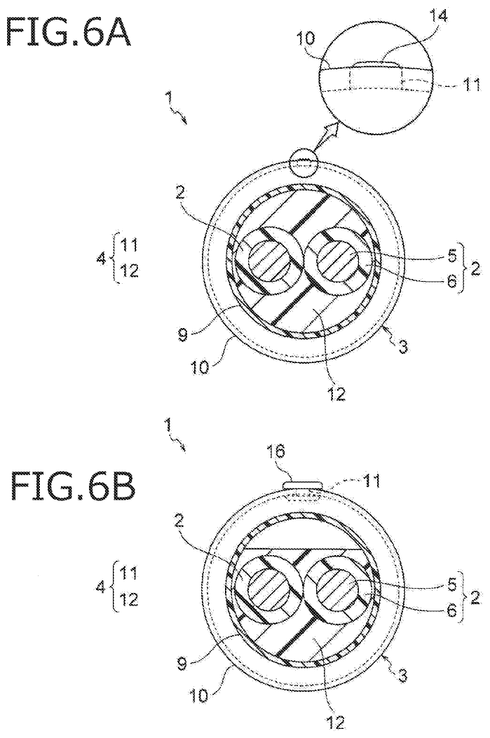

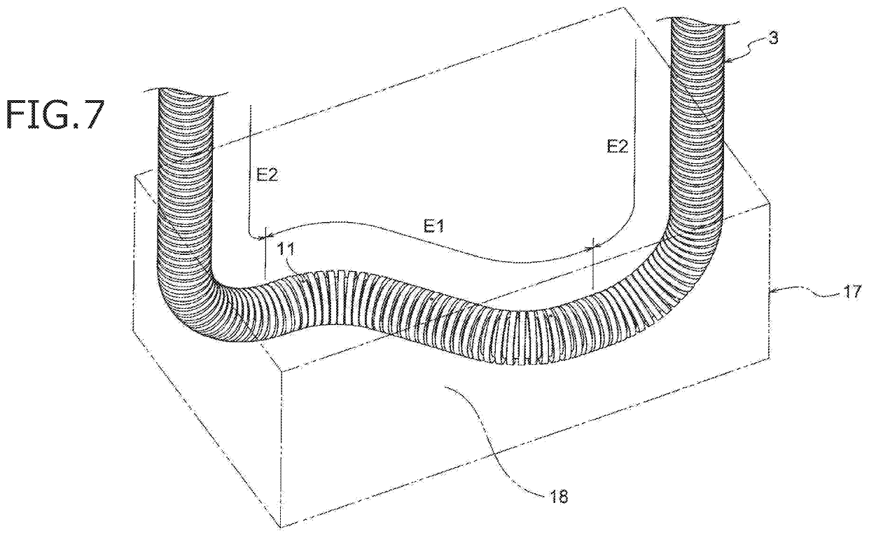

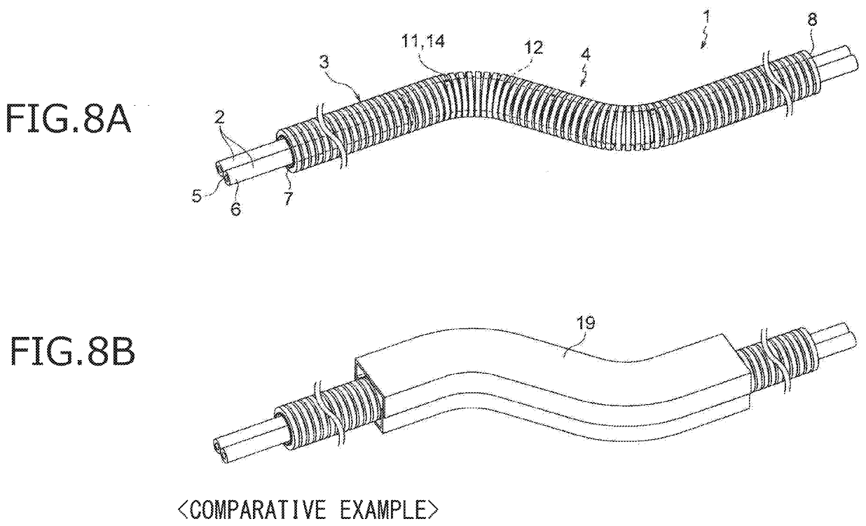

Embodiments will be described below with reference to the drawings. FIGS. 1A and 1B show a wire harness according to an embodiment of the present invention, FIG. 1A is a perspective view, and FIG. 1B is a perspective view in which a tubular body is shown by a two-dot chain line. FIG. 2 is an enlarged perspective view of a route regulation portion of FIGS. 1A and 1B, and FIG. 3 is a perspective view of electric wires and a cured portion in the state of FIGS. 1A and 1B. FIGS. 4A and 4B show a method for manufacturing a wire harness according to an embodiment of the present invention, and FIGS. 4A and 4B illustrate a first step. FIGS. 5A, 5B and 5C show a second step of the method for manufacturing a wire harness, FIG. 5A illustrates a holding step in the second step, FIG. 5B illustrates an injection step, and FIG. 5C illustrates a curing step. FIGS. 6A and 6B are cross-sectional views showing a state of the cured portion, FIG. 6A shows that a hole blocking portion is formed, and FIG. 6B shows that a plug member is attached. FIG. 7 illustrates a jig used in the method for manufacturing a wire harness. FIG. 8A shows that a route-regulated portion is not enlarged in size as compared with that shown in FIG. 8B, FIG. 8A is a perspective view showing the wire harness of FIGS. 1A and 1B, and FIG. 8B is a perspective view showing a wire harness as a comparative example.

### Configuration of Wire Harness 1

In FIGS. 1A and 1B, a wire harness is indicated by the reference numeral 1. The wire harness 1 is routed in an automobile in the present embodiment. The routing destination is not limited to the automobile. For example, the routing destination may be a place, where electrical connection is required, in such as a ship, a motorcycle, an aircraft, a large facility, and a plant. In addition, the wire harness 1 may be long or short. Further, the wire harness 1 may correspond to a high voltage or a low voltage. The wire harness 1 of the present embodiment includes two electric wires 2, a tubular body 3 for accommodating and protecting the two electric wires 2, and a connector (not shown) provided at ends of the two electric wires 2. Although not shown here, the two electric wires 2 may be covered by a tubular braid. Since the tubular braid is used for providing an electromagnetic shield, the braid is formed by braiding fine metal wires. In addition to the braid, metal foil or a sheet member containing metal foil may be used instead of or in addition to the braid. The wire harness 1 requires route regulation when being routed, and includes one or a plurality of route regulation portions 4. The route regulation portion 4 is a feature of the present invention.

### Electric Wire 2

In FIGS. 1A and 1B, each of the electric wires 2 includes a conductive metal conductor 5 and an insulating resin insulator 6 that covers the conductor 5. The electric wires 2 are flexible from one end to the other end thereof respectively. In the present embodiment, an electric wire having no sheath is adopted as an example of each of the electric wires 2. Since the electric wires 2 do not have sheaths respectively, it is needless to say that the electric wires 2 are lighter accordingly (if the electric wires 2 are long, the weight can be significantly reduced as compared with one having the sheath). Although the number of the electric wires 2 in the present embodiment is two, the number is an example. Further, although the two electric wires 2 are shown with the same thickness, the thickness is also an example.

The conductor 5 is formed by a copper, a copper alloy, an aluminum or an aluminum alloy and has a circular cross section. The conductor 5 may have either a conductor structure formed by twisting a wire, or a rod-shaped conductor structure having a circular cross section (round shape) (for example, a round single-core conductor structure, in this case, the electric wire 2 itself is also rod-shaped. However, a soft conductor structure in which the route regulation portion 4 to be described later is required may be used). The insulator 6 made of an insulating resin material is extruded on an outer surface of the conductor 5. The insulator 6 is extruded on an outer peripheral surface of the conductor 5 using a thermoplastic resin material. The insulator 6 is formed as a coating having a circular cross section. The insulator 6 is formed to have a predetermined thickness. As the thermoplastic resin, various known types can be used, and for example, the thermoplastic resin is appropriately selected from a polymer material such as a polyvinyl chloride resin, a polyethylene resin, or a polypropylene resin.

### Tubular Body 3

In FIGS. 1A and 1B, the tubular body 3 is provided for accommodating and protecting the two electric wires 2 as described above. The tubular body 3 of the present embodiment has a circular cross section, and is formed in a cylindrical shape by extending the circular shape. The cross section of the tubular body 3 is not limited to a circular shape, and may be an elliptical shape, an elliptical shape, and the like. The cross-sectional shape of the tubular body 3 is set as appropriate according to the number of the electric wires 2, the routing space, and the like. A circular opening is formed at one end 7 and the other end 8 of the tubular body 3. An opening diameter is set to a size that is slightly larger than a width of the two electric wires 2 arranged adjacently. The tubular body 3 is formed in a shape having no slit from one end 7 to the other end 8. In other words, the tubular body 3 is formed in a shape without being cut. With such a shape having no slit, the tubular body 3 is formed such that the two electric wires 2 are inserted from the one end 7 or the other end 8 and are protected. The tubular body 3 of the present embodiment is formed in a bellows shape in which bellows projection portions 9 and bellows recess portions 10 in a circumferential direction are alternately continuous in a tube axis CL direction (with reference to FIGS. 4A and 4B). The tubular body 3 is not limited to the bellows shape. The tubular body 3 may be a resin tube having a uniform thickness without irregularities. Since the tube 3 of the present embodiment has a bellows shape, a corrugated tube is adopted. A plurality of injection holes 11 are formed in the tubular body 3. The injection hole 11 will be described later.

### Route Regulation Portion 4

In FIGS. 1A, 1B and 2, the route regulation portion 4 has a predetermined range E1 in the tube axis CL direction (with reference to FIGS. 4A and 4B) which is formed into a desired route shape. The predetermined range E1 is a range in which the route needs to be regulated, and in an example in the related art, the range E1 is a range in which the protector needs to be attached. That is, the range E1 is a range in which a change of the shape related to the routing from a desired route shape is restricted. Meanwhile, the desired route shape is, for example, a bent shape as shown in the drawing or a linear shape (not shown). More specifically, the desired route shape includes various shapes such as a two-dimensional substantially S-shaped (substantially crank shape) bent shape as shown in the figure, a straight line shape, a three-dimensional substantially S shape, a three-dimensional twisted shape, and a three-dimensional substantially stair shape. The symbol E2 in FIG. 1A indicates a flexible range. That is, the range E2 is a range in which the flexibility of the tubular body 3 remains with no route regulation portion 4 and, for example, a bending operation during routing can be easily performed. The route regulation portion 4 includes a plurality of injection holes 11 and a cured portion 12.

### Injection Hole 11 and Cured Portion 12

In FIGS. 1A, 1B and 2, the injection hole 11 is provided in the peripheral wall of the tubular body 3 so as to penetrate into inside the peripheral wall. The injection hole 11 of the present embodiment is formed in a circular shape, but the shape can be appropriately set into, for example, a rectangular shape according to a shape of a nozzle 15 to be described later. Further, the injection hole 11 of the present embodiment is formed to have a small opening in an upper part of the bellows projection portion 10 in the figure, but may be formed to have a relatively large opening including the bellows projection portion 9. The number, opening shape, and arrangement of the injection holes 11 are set as appropriate according to a fluid 13 (to be described later) serving as a source of the cured portion 12. The injection hole 11 is formed at the same time as the tubular body 3 is formed, or is formed when the fluid to be described later is injected.

The cured portion 12 is a portion injected through the injection holes 11 and cured in the tubular body 3. The fluid 13 serving as the source of the cured portion 12 is a resin material (curable resin, plastic resin, adhesive, etc.) or a rubber material that is cured in the tubular body 3, and a foamed material or a non-foamed material may be used. For example, the fluid 13 serving as the source of the cured portion 12 has a certain degree of viscosity and stops in the predetermined range E1 before being cured. Further, for example, the fluid 13 serving as the source of the cured portion 12 is cured in a short time. Of course, for example, the fluid 13 serving as the source of the cured portion 12 has good compatibility with the material of the tubular body 3 and the material of the insulator 6 of the electric wire 2. In the present embodiment, an epoxy resin-based adhesive that is cured by heat is used as the fluid 13 serving as the source of the cured portion 12 (the adhesive is an example and the fluid is not limited thereto). The fluid 13 serving as the source of the cured portion 12 is injected into (fills) an inside of the tubular body 3 in an amount capable of forming the predetermined range E1 into a desired route shape in a state of being cured in the cured portion 12.

In FIGS. 1A to 3, the cured portion 12 is formed so as to completely fill the inside of the tubular body 3 or to such an extent that the two electric wires 2 are buried, in the predetermined range E1. The cured portion 12 is formed so as not return to an original straight state if the desired route shape is a bent shape. Further, the cured portion 12 is formed so as not to bend if the desired route shape is a linear shape. The cured portion 12 of the present embodiment is formed such that the two electric wires 2 are held and does not vibrate (flap) in the tubular body 3. Since the tubular body 3 has a bellows shape, the cured portion 12 is engaged with unevenness on an inner surface of the tubular body 3 to prevent displacement in the tube axis CL direction (with reference to FIGS. 4A and 4B). If the cured portion 12 is not displaced, the function as the route regulation portion 4 can be maintained. When the cured portion 12 completely fills the inside of the tubular body 3 in the predetermined range E1, a hole blocking portion 14 is formed on the cured portion 12. The hole blocking portion 14 is formed in a portion that blocks the injection hole 11 in a state where the injection hole 11 is buried. A shape of the cured portion 12 is schematically shown.

### Method for Manufacturing Wire Harness 1

Hereinafter, a method for manufacturing a wire harness 1 of FIGS. 1A and 1B will be described. The wire harness 1 is manufactured through a first step and a second step. In FIGS. 4A and 4B, in the first step, the two flexible electric wires 2 are accommodated in the tubular body 3 which is flexible and is formed in a straight shape having no slit from one end 7 to the other end 8. The two electric wires 2 are formed to be slightly longer than the tubular body 3, and connectors (not shown) are attached to end portions protruding from one end 7 and the other end 8 of the tubular body 3. The product manufactured in the first step is brought into a compacted state, for example, by rolling or folding, and then is accommodated in a box and transported to a wire harness routing site. The transportation to the wire harness routing site is an example, and the second step may be performed on the same manufacturing line immediately after the first step.

In FIGS. 5A to 5C, the second step is a step of forming the cured portion 12 in the predetermined range E1 to obtain a desired route shape. That is, the second step is a step related to forming of the route regulation portion 4. In the second step, a holding step, an injection step, and a curing step are sequentially performed. First, in the holding step, the predetermined range E1 is held in a desired route shape while being remained in a flexible state, as shown in FIG. 5A. For example, a jig for holding is used. Next, in the injection step, the fluid 13 serving as the source of the cured portion 12 is injected into the tubular body 3 through the plurality of injection holes 1, as shown in FIG. 5B. For injection, the nozzle 15 is used (the nozzle 15 is provided in a dispenser device). At last, in the curing step, the fluid 13 is cured. The cured portion 12 is formed in the tubular body 3 by the curing step, and thus the route regulation portion 4 having a desired route shape is formed in the predetermined range E1.

If the cured portion 12 is formed as shown in FIG. 6A, the injection hole 11 is blocked by the hole blocking portion 14. Further, if the cured portion 12 is formed as shown in FIG. 6B, the injection hole 11 is blocked by a plug member 16 (or a tape winding portion formed by known tape winding). The plug member 16 and the like can prevent intrusion of dust or moisture from the injection hole 11.

Here, a supplementary description will be given for the second step, and a jig 17 as shown in FIG. 7 may be used in the second step. A holding portion 18 is formed in the jig 17. The holding portion 18 is formed at a portion where the predetermined range E1 is set in the vicinity thereof, that is, lower than the flexible range E2. By using the jig 17, the fluid 13 serving as the source of the cured portion 12 can be kept in the predetermined range E1, for example, even without using a special device such as a suction device.

As described above with reference to FIGS. 1A to 7, according to the wire harness 1 of the embodiment of the present invention, since the route regulation portion 4 is provided, the predetermined range E1 can be formed into a desired route shape by the route regulation portion 4. Since the cured portion 12 for forming the route regulation portion 4 is formed in the tubular body 3, as shown in FIG. 8A, the portion where the route regulation portion 4 is formed is not thickened (when a protector 19 is provided as in the comparative example, the portion is thickened). Since the route regulation portion 4 is not a product molded by a mold, it can be relatively easy to handle the case in which the route regulation range and shape are diversified. Further, the injection hole 11 for forming the route regulation portion 4 is a hole penetrating the peripheral wall of the tubular body 3, which does not lead to an increase in the number of components that complicates management. Further, since the cured portion 12 for forming the route regulation portion 4 is also a portion that is injected through the injection holes 11 and cured in the tubular body 3, similarly, which does not lead to an increase in the number of components that complicates the management. In the route regulation portion 4, if the cured portion 12 is formed such that the two electric wires 2 are buried as shown in FIGS. 6A and 6B, vibration of the two electric wires 2 can be prevented. In other words, the flapping of the electric wires 2 in the tubular body 3 can be eliminated, thus preventing damage to the electric wires 2 and contributing to function maintaining. In addition, the tubular body 3 is formed in a shape having no slit from one end 7 to the other end 8, which can contribute to prevention of intrusion of dust or moisture. As described above, in the wire harness 1, the degree of freedom regarding the route regulation can be increased and the route-regulated portion can be prevented from being enlarged in size as compared with the example in the related art. Further, according to the method for manufacturing a wire harness of the embodiment of the present invention, it is possible to manufacture the wire harness 1 which has the above-described features and is provided with the route regulation portion 4.

It goes without saying that the invention can be variously modified without departing from the spirit of the invention.

What is claimed is:

1. A wire harness, comprising:
an electric wire having flexibility; and
a flexible tubular body that has no slit on an entire region from one end to the other end of the tubular body and accommodates the electric wire, wherein
a route regulation portion for restricting the tubular body to a desired route shape is provided in a predetermined range of the tubular body in a tube axis direction of the tubular body in a state where the electric wire is accommodated in the tubular body; and
the route regulation portion has an injection hole that is provided in a peripheral wall of the tubular body so as to pass through the peripheral wall, and a cured portion that is injected through the injection hole and is cured in the tubular body.

2. The wire harness according to claim 1, wherein
the cured portion has a hole blocking portion that blocks the injection hole.

3. The wire harness according to claim 1, wherein
the route regulation portion further has a plug member or a tape winding portion that blocks the injection hole.

4. The wire harness according to claim 1, wherein
the tubular body is formed in a bellows shape in which bellows projection portions and bellows recess portions extending in a circumferential direction of the tubular body are alternately and continuously arranged in the tube axis direction.

5. The wire harness according to claim 1, further comprising:
a braid that covers the electric wire and is accommodated in the tubular body together with the electric wire.

6. A method for manufacturing a wire harness, comprising:
accommodating an electric wire having flexibility in a flexible tubular body having no slit on an entire region from one end to the other end of the tubular body; and
forming a cured portion in a predetermined range of the tubular body in a tube axis direction of the tubular body after an accommodating process of the electric wire to form a route regulation portion which restricts the tubular body to a desired route shape, wherein
a forming process of the cured portion comprises:
holding the predetermined range of the tubular body in the desired route shape while a flexible state of the tubular body is maintained;
injecting a fluid to be the cured portion through an injection hole provided in a peripheral wall of the tubular body into inside the tubular body, and
curing the fluid to form the cured portion in the tubular body.

7. The method according to claim 6, wherein
a jig used in the forming process of the cured portion has a holding portion that holds the predetermined range of the tubular body in a lower position lower than a part of the tubular body other than the predetermined range of the tubular body.

8. The method according to claim 6, wherein
the forming process of the cured portion is performed in a vicinity of a place where a wire harness routing of the wire harness is performed.
